(19) United States
(12) Patent Application Publication
(10) Pub. No.: US 2010/0193658 A1
(43) Pub. Date: Aug. 5, 2010

(54) MOTORIZED MOUNT

(76) Inventors: Lawrence J. Beger, Chicago, IL (US); Mark Hartelius, Chicago, IL (US)

Correspondence Address: CARDINAL LAW GROUP, LLC, SUITE 2000, 1603 ORRINGTON AVENUE, EVANSTON, IL, 60201, US

(21) Appl. No.: 12/483,923

(22) Filed: Jun. 12, 2009

Related U.S. Application Data
(60) Provisional application No. 61/061,045, filed on Jun. 12, 2008.

(30) Foreign Application Priority Data
Jun. 12, 2009 (US) PCT/US2009/047325

(51) Int. Cl. F16M 13/02; F16M 13/00; A47F 5/00

(52) U.S. Cl. 248/542; 248/298.1

(57) ABSTRACT

A video monitor mount includes at least a first hook and a wall mount. The mount further includes a monitor mount plate, a first motor for driving a pan gear along a first axis and a second motor for driving a tilt gear. The tilt gear includes a plurality of teeth along a first side of the tilt gear, a substantially straight portion, and a curved portion. Translation of a mating gear connected to the monitor mount plate along the tilt gear moves the monitor mount plate in a first direction substantially parallel with the substantially straight portion and in a direction substantially parallel with the curved portion responsive to the position of the monitor mount plate relative to the tilt gear.

### RELATED APPLICATIONS

This application claims the benefit of, and priority to, U.S. Provisional Patent Application 61/061,045 filed Jun. 12, 2008, the entirety of which is incorporated herein by reference.

### FIELD OF THE INVENTION

The present invention generally relates to video monitor wall mounts. More specifically, the invention is directed to a motorized mount.

### BACKGROUND OF THE INVENTION

Current video monitor technology is moving rapidly to flat screens. LCD and plasma screens are popular flat screen products. These flat screens can be mounted in a traditional manner on a horizontal surface by placement on a stand. It is also now popular to mount flat screens on a wall. Video monitor wall mounts either have an adjustable tilt or a fixed position. Retailers use valuable shelf space to stock each type of product. Consumers are forced to choose one type of mount or the other before even using the product; whereas, consumers often do not decide what they prefer until after having a chance to try both configurations where they choose to install it. Consumers also sometimes change the location of their video monitors and would prefer to change the configuration of their wall mount once they relocate it.

Once mounted, however, the television has typically required physical intervention to move or adjust positions. Prior solutions include addition of motors to move the television in a three dimensional space, but obtaining movements in the three dimensions has required use of three motors to pan, tilt, and extend the monitor. Such solutions are adequate, but the use of three motors adds costs as well as weight to the mount. This additional weight must be considered for rating how much weight the mount can support, since the mount must also support its own weight.

It is an object of this invention, therefore, to overcome the deficiencies and obstacles described above.

The aforementioned and other features and advantages of the invention will become further apparent from the following detailed description of the presently preferred embodiments, read in conjunction with the accompanying drawings. The detailed description and drawings are merely illustrative of the invention rather than limiting the scope of the invention being defined by the appended claims and equivalents thereof.

### SUMMARY OF INVENTION

A first aspect of the invention provides a video monitor mount that includes at least a first hook and a wall mount, the mount including monitor mount plate, a first motor for driving a pan gear along a first axis and a second motor for driving a \tilt gear, the tilt gear including a plurality of teeth along a first side of the tilt gear, the first side including a substantially straight portion and a curved portion, and wherein translation of a mating gear connected to the monitor mount plate along the tilt gear moves the first hook in a first direction substantially parallel with the substantially straight portion and in a direction substantially parallel with the curved portion responsive to the position of the hook relative to the tilt gear.

### BRIEF DESCRIPTION OF THE DRAWINGS

FIG. 1 illustrates a video monitor mount in accordance with one aspect of the invention.

FIG. 2 illustrates a pan gear in accordance with one aspect of the invention;

FIG. 3 illustrates a tilt gear in accordance with one aspect of the invention; and

FIG. 4 illustrates a mating gear in accordance with one aspect of the invention.

### DETAILED DESCRIPTION OF THE PREFERRED EMBODIMENTS

The attached figures illustrate various features of the invention. Other variations and combinations of features will be apparent to those with skill in the art. Those variations are included within the disclosure herein.

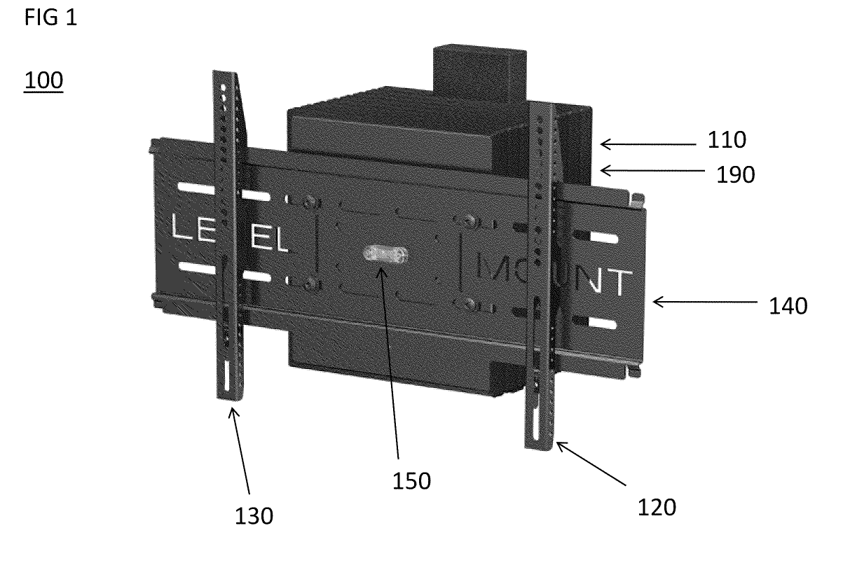

FIG. 1 illustrates a video monitor mount 100 including a wall mount portion 110 and first hook 120 and second hook 130. Video monitor mount 100 further includes a monitor mount plate 140 and an integral bubble level 150. First hook 120 and second hook 130 are removably attached (shown attached) to the monitor mount plate 140 and are each configured to be affixed to a video monitor (not shown) via fasteners such as screws. The first hook 120 and second hook 130 may translate along the monitor mount plate 140 freely in certain embodiments, or their travel may be restricted by either fasteners or by ridges. The first hook 120 and the second hook 130 may be configured with fasteners arrayed according to a standard, such as a VESA standard, or may be configured to accept adaptors for mounting monitors. FIG. 1 further illustrates shawl 190 covering the moving portions of the video monitor mount 100 such as the pan gear and tilt gear described below. Shawl 190 is illustrated in FIG. 1, although shawl 190 is only utilized in certain embodiments of the invention.

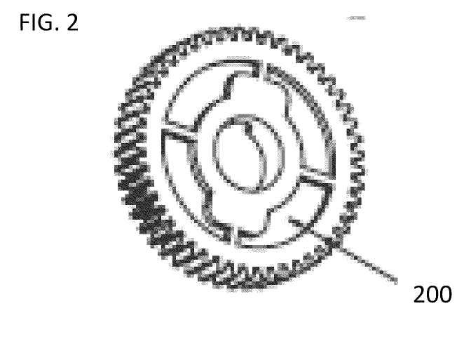

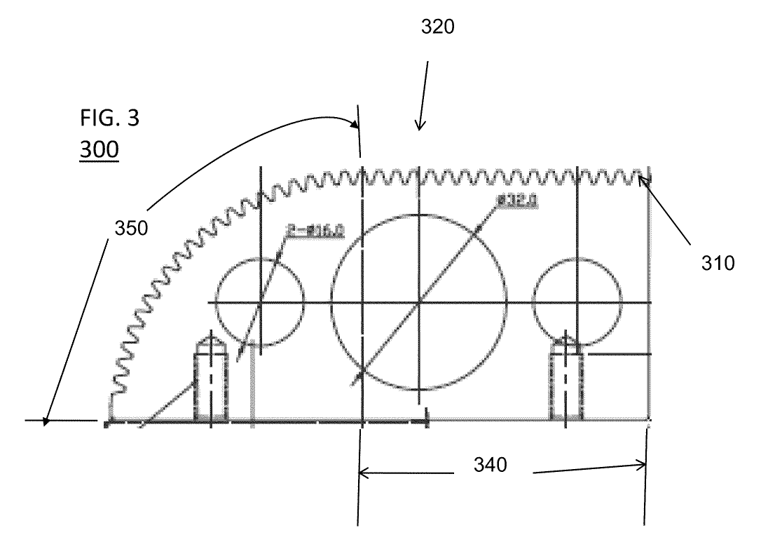

Wall mount portion 110 includes a first motor for driving a pan gear (FIG. 2) along a first axis and a second motor for driving a tilt gear (FIG. 3). The wall mount portion is configured to attach to a surface, such as a wall using fasteners, such as screws. The bubble level 150 may be utilized to ensure that the mounting of the wall mount portion 110 is level. The wall mount portion extends and places the monitor mount plate 140 away from the wall a variable distance responsive to the position of the tilt gear (FIG. 3).

FIG. 2 illustrates a pan gear 200 in accordance with one aspect of the invention. Pan gear 200 includes a surface configured to rotate the monitor mount plate along a first radius. The motor driving pan gear 200 can be any standard motor.

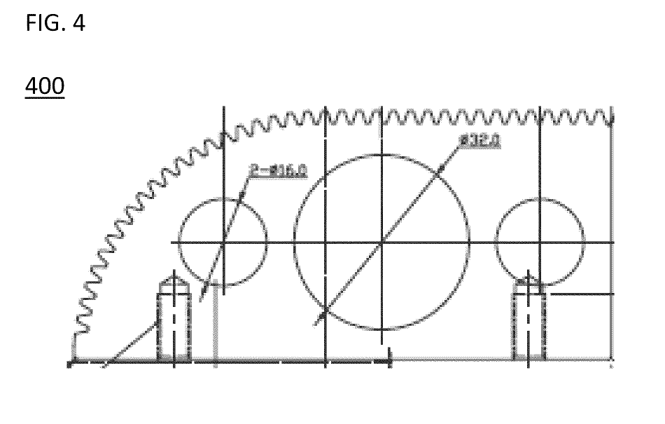

FIG. 3 illustrates a tilt gear 300 in accordance with one aspect of the invention. Tilt gear 300 includes a plurality of teeth 310 along a first side 320 of the tilt gear 300. The first side includes a substantially straight portion 340 and a curved portion 350. Translation of a mating gear 400 (FIG. 4) connected to the monitor mount plate (140, FIG. 1) along the tilt gear 300 moves the monitor mount plate in a first direction substantially parallel with the substantially straight portion 340 and in a direction substantially parallel with the curved portion 350 responsive to the position of the monitor mount plate relative to the tilt gear. The tilt gear 300 thus allows movement of the monitor mount plate along both a second axis and substantially continuously varying axes using a single gear.

FIG. 4 illustrates one embodiment of a mating gear 400 in accordance with one aspect of the invention. Mating gear 400 includes a surface configured to move the monitor mount plate along a first radius. As shown in FIG. 4, mating gear 400 is substantially similar to tilt gear 300, although other configurations of the mating gear 400 are anticipated, such as a gear solely incorporating a straight portion, a substantially circular gear, or a ovoid gear including a plurality of radii.

Those of skill in the art will recognize that the use of the tilt gear 300 allows for motorized movement of the monitor mount plate 140 (and thus any video monitor mounted thereon) along three axes, but using only two motors.

1. A video monitor mount comprising:
at least a first hook; and
a wall mount, the mount including monitor mount plate, a first motor for driving a pan gear along a first axis and a second motor for driving a \tilt gear, the tilt gear including a plurality of teeth along a first side of the tilt gear, the first side including a substantially straight portion and a curved portion, and wherein translation of a mating gear connected to the monitor mount plate along the tilt gear moves the first monitor mount plate in a first direction substantially parallel with the substantially straight portion and in a direction substantially parallel with the curved portion responsive to the position of the monitor mount plate relative to the tilt gear.

2. The mount of claim 1 further comprising a bubble level integral with the monitor mount plate.

3. The mount of claim 1 further comprising a shawl covering the pan gear and tilt gear.
